(19) United States
(12) Patent Application Publication
(10) Pub. No.: US 2020/0322664 A1
(43) Pub. Date: Oct. 8, 2020

(54) SYSTEM AND METHOD FOR AI DRIVEN ORCHESTRATION AUTOMATION OF LIVE PRODUCTION & CHANNEL PLAYOUT

(71) Applicant: GRASS VALLEY CANADA, Montreal (CA)

(72) Inventors: Alex HOLTZ, Suwanee, GA (US); Charles S. MEYER, Crystal Bay, NV (US)

(21) Appl. No.: 16/837,648

(22) Filed: Apr. 1, 2020

Related U.S. Application Data
(60) Provisional application No. 62/830,268, filed on Apr. 5, 2019.

(51) Int. Cl. H04N 21/25; H04N 21/2187; H04N 21/258

(52) U.S. Cl. CPC H04N 21/251; H04N 21/25891; H04N 21/25808; H04N 21/2187

(57) ABSTRACT

A system is provided for live video production and asset management that includes an orchestration software and platform that uses artificial intelligence or machine learning to automate show rundown and playlist assembly based on social topical trends, historical and predictive content and associated advertising performance by type and consumer demographics by platform viewership. The system and method provides an automated lineup (or suggested lineup that can be modified by the producer) of the best predictive performance results rather than solely based on experience of the producer himself or herself.

### CROSS REFERENCE TO RELATED APPLICATIONS

The present application claims priority to U.S. Patent Provisional Application No. 62/830,268, filed Apr. 5, 2019, the contents of which are hereby incorporated in their entirety.

### TECHNICAL FIELD

The present disclosure relates generally to live video production, asset management, and, more particularly, to a system and method for AI driven orchestration automation of live production and channel playout.

### BACKGROUND

In today's video production environment, producing live shows are dependent upon the existing tools available, which vary depending on the application. For example, a live newscast is prepared on a News Room Computer System (“NRCS”). This is the tool used to structure the running order of stories and advertisement breaks based on the experience of the producer and timing allocations to maximize viewership and monetization. Another tool used in news is the Production and/or Media Asset Management (“PAM” or “MAM”) that manages the production, storage and publishing of content. Currently, this tool performs many functions from ingest, logging and editing the content to monitoring social platforms for trending topics and planning different ways to tell a story based on its platform destination and how it will be consumed. Using current technologies, all of these processes and decisions are based on the experiences of a person (i.e., a producer or editor) to prioritize how best to present the content and the timing for doing so. For example, the content may be presented live as a breaking news story on a social platform or on the broadcaster's website and mobile application to drive viewership interest as the story develops or they may opt to wait for the scheduled linear broadcast. Again, these decisions are based on experience of the product and/or editor.

Like news, in live sports and entertainment, decisions are also made during the live event based on the experience of the producer and/or director. Typically, a loose form of a planning script is used, but it is quickly overridden in most instances based on key highlights that occur during a game or event, for example. The orchestration of the live production is driven by the director calling the show as events occur such as an interesting replay of a close penalty call or scoring play or how a transition between camera shots or multiple shots are called and displayed. Since sports and entertainment applications are not scripted, precise human communications between the producer, director, video production switcher technical director, replay operators, camera operators, graphics operators, statisticians, audio engineer, and the like, is paramount to producing a live event that is well received by consumers.

To broadcast such events, channel playout provides the transmission of radio or TV channels from the broadcaster into broadcast networks that delivers the content to the audience. As such, channel playout deals with show level versus event level resolution and enables a producer to plan a daily schedule not only based on required agreements, but also personalization based on micro-channel requests. For example, if a local broadcaster wanted to provide a channel playout feed specifically for a mobile application, the broadcaster may opt to personalize the playlist based on the user's profile and topical interests such as providing stories on sports and healthcare versus human interests or finance as it related to local events. To address this application today, data collected at the client application would need to be collected and archived by the publisher and associated with the story topic, time of day, duration of engagement and ad performance metrics collected by a Data Management Platform (“DMP”) and then used to automate the process of playlist construction and management.

In a related aspect of such content distribution, the ROI model business cycle has been improved by providing the flexibility to offer up different IaaS platforms for commodity services provided by Amazon AWS®, Google Cloud® and Microsoft Azure®. These services may include Encode/Transcode, Server-Side Dynamic Ad Insertion, Data Management, Content Delivery Network and Demand-Side Platform Advertising and along with third party partners for Online Video Platforms and Content Management Systems. Moreover, total cost, platform costs, bandwidth requirements and scale pricing must be constantly monitored as an input to maximize returns and decisioning on platform of choice.

### SUMMARY OF THE INVENTION

In view of the current landscape for live video production and asset management, the present disclosure provides a system and method that improves the process of any broadcast that is currently structured and based on human experience versus data science. In an exemplary aspect, the development of an orchestration software and/or platform that uses artificial intelligence (“AI”) to automate show rundown (i.e., topical or story level for LIVE) and playlist (for PLAYOUT) assembly based on social topical trends, historical and predictive content and associated advertising performance by type and consumer demographics by platform viewership to maximize ROI is described. The disclosed system and method provides an automated lineup (or suggested lineup that can be modified by the producer) of the best predictive performance results rather than solely based on experience of the producer himself or herself.

In exemplary aspects, the automated lineup that is generated using AI can be applied to a news rundown, a live sports or entertainment event or channel playout application. For example, the exemplary system and method is configured using AI to predict the most likely lineup that provides the best return on investment based on viewer engagement expectations.

Moreover, rather than an automated running order, AI based instructions and control based on historical archives and real-time social and interactive feedback can facilitate the decision making during the show. In an exemplary aspect, this process can involve automated requests of player performance metrics or camera angles as commentators call the on-air show and discuss specific plays or predictions of what plays should be called next. By doing so, the system and method create an automated analysis for facilitating decision making. In this instance, a human operator cannot possibly calculate and cost optimize for multiple distribution models, simultaneously. The system can effectively perform these calculations to use data feeds on a margin basis to generate additional income that was previously inaccessible, for example, for high volume and lower value (e.g., highlights played out to mobile devices where per viewer revenue is low, but high volume generates overall revenue).

Yet further, similar to dynamic CDN changes based on most direct path versus price, the same can be argued about the use of such commodity services described above. Therefore, in another exemplary aspect, the exemplary system and method is configured to utilize platform performance metrics over time to provide more precise decisioning based on ROI.

According to an exemplary aspect, a system is provided for orchestrating automation of live production and channel playout. In this aspect, the system includes a performance metrics analyzer configured to generate historical performance metrics based on a historical archive review and prioritization of media content; a predictive performance indicator configured to monitor and identify at least one topic of interest that aligns with the generated historical performance metrics for decisioning; a platform performance metrics module configured to generated performance metrics for at least one downstream platform with at least one of targeted consumer profiles, advertiser interests and predictive ROI based on content type, duration, real time trends and performance metrics; a ROI projector configured to access at least one of social and interactive platforms to derive at least one level of interest for a specific content type and categories for selection and duration of engagement based on the generated historical performance metrics for decisioning and the generated performance metrics for at least one downstream platform, to generate a projected ROI performance based on historical metrics; and a prioritization and order generator configured to learn and predict variations of the projected ROI performance to establish a best prioritization and order for at least one of rundown and a playlist for live video production, wherein the prioritization and order generator is further configured to generate a user interface configured to receive weighting factors for at least a portion of the historical performance metrics, at least one topic of interest that aligns with the generated historical performance metrics for decisioning, and the generated performance metrics for at least one downstream platform, and wherein the prioritization and order generator is configured to dynamically adjust the established best prioritization and order for the at least one of rundown and a playlist in response to an adjustment by the user of the weighting factors.

In another exemplary embodiment, a system is provided for orchestrating automation of live production and channel playout. In this aspect, the system includes an analytics engine configured to generate historical performance metrics based on a historical archive review and prioritization of media content, wherein the analytics engine includes a platform performance metrics module configured to generate performance metrics for at least one downstream platform with at least one of targeted consumer profiles, advertiser interests and predictive ROI based on content type, duration, real time trends and performance metrics. Moreover, the system further includes a recommendation engine configured to monitor and identify at least one topic of interest that aligns with the generated historical performance metrics for decisioning, wherein the recommendation engine includes a ROI projector configured to access at least one of social and interactive platforms to derive at least one level of interest for a specific content type and categories for selection and duration of engagement based on the generated historical performance metrics for decisioning and the generated performance metrics for at least one downstream platform, to generate a projected ROI performance based on historical metrics. Yet further, the system includes an orchestration engine configured to learn variations of the projected ROI performance to establish an optimal prioritization and order for at least one of rundown and a playlist for live video production; and a media content distribution server configured to distribute media content for the live video production based on the established optimal prioritization and order for the at least one of the rundown and playlist.

According to an exemplary aspect, the orchestration engine is further configured to generate a user interface configured to receive weighting factors for at least a portion of the historical performance metrics, at least one topic of interest that aligns with the generated historical performance metrics for decisioning, and the generated performance metrics for at least one downstream platform configured to receive the live product including the media content. Moreover, the orchestration engine is further configured to dynamically adjust the established optimal prioritization and order for the at least one of rundown and a playlist in response to an adjustment of the weighting factors received by the user interface.

In another exemplary aspect, the orchestration engine is further configured to embed an additional graphic relating to the identified at least one topic of interest into the live video production.

In another exemplary aspect, the analytics engine is further configured to monitor viewership of the live product and to dynamically update the established optimal prioritization and order for the at least one rundown or playlist based on feedback data of the monitored viewership.

In another exemplary aspect, the orchestration engine is configured to dynamically update the established optimal prioritization and order for the at least one rundown or playlist by dropping a story based on the feedback data of the monitored viewership.

In yet another exemplary aspect, the orchestration engine is configured to use at least one of infrastructure as code and configuration as code to establish the optimal prioritization and order for the at least one of the rundown and the playlist for the live video production.

In another exemplary aspect, the analytics engine is configured to monitor a video output signal of the live video production to identify an error with content delivery of the live video production, with the error being one of a blackout, a program output freeze, an audio lip sync misalignment and a pixelization error.

Yet further, in another exemplary aspect, the orchestration engine is configured to dynamically update the established optimal prioritization and order for the at least one rundown or playlist in response to the identified error of the content delivery.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplary pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a high-level block diagram of an exemplary system 100 for AI driven orchestration automation of live production and channel playout according to an exemplary embodiment.

FIG. 2 illustrates a block diagram of the orchestration manager implemented for AI driven orchestration automation of live production and channel playout according to an exemplary embodiment.

FIG. 3 illustrates a detailed block diagram of an exemplary system for AI driven orchestration automation of live production and channel playout according to an exemplary embodiment.

FIG. 4 illustrates a flowchart for configuring orchestration manager according to an exemplary aspect.

FIG. 5 is a block diagram illustrating a computer system on which aspects of systems and methods for AI driven orchestration automation of live production and channel playout according to an exemplary embodiment.

### DETAILED DESCRIPTION

Various aspects of the disclosure are now described with reference to the drawings, wherein like reference numerals are used to refer to like elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below. In other instances, well-known structures and devices are shown in block diagram form in order to facilitate description of one or more aspects. The following presents a simplified summary of one or more aspects of the disclosure in order to provide a basic understanding thereof.

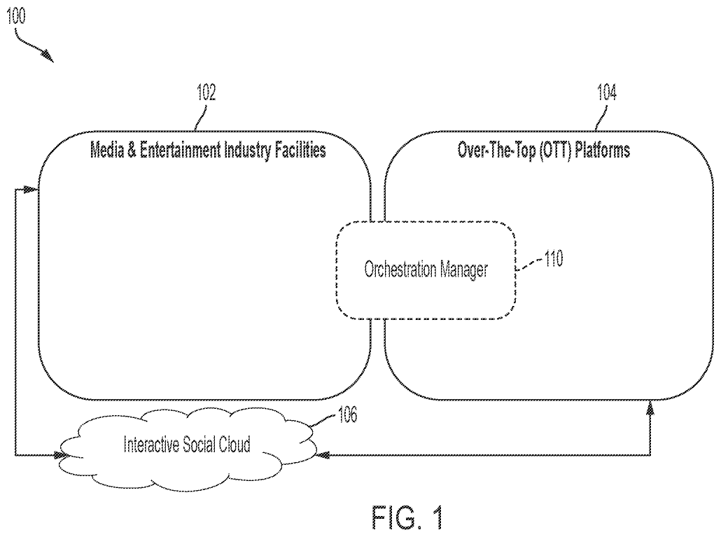

FIG. 1 illustrates a high-level block diagram of an exemplary system for AI driven simultaneous orchestration automation of live production and channel playout according to an exemplary embodiment.

As shown, the diagram illustrates a system 100 the defines the relationships and required data exchange between ecosystem categories. In general, the system can include media and entertainment industry facilities 102, over-the-top (OTT) platforms 104, and an interactive social cloud 106. Moreover, an orchestration management layer (or simply “orchestration manager” 110) is provided within the ecosystem and configured to control and/or configure components within the facility 102, such as a newsroom computer system (MRCS), media asset management (MAM), automated production control (APC) and multi-platform channel playout system that serves both traditional over-the-air, cable, satellite or IPTV distribution and the OTT platforms/applications 104.

In general, the orchestration manager 110 can be one or more software applications or platforms that is configured to automate the assembly of rundowns in newsroom computer systems or any other live production running order and playlist assembly for channel playout systems and applications. More particularly, the orchestration manager 110 is configured to use AI and/or machine learning to automatically either prioritize a story selection for live streaming or publishing and/or assemble a show running order (i.e., the “rundown”) or scheduled channel playout list based on the platform destination of choice. As a result, the system is configured to dynamically assemble a unique list for each destination (e.g., each content consuming device). Thus, for each assembled playout list, the orchestration manager 110 can cause the system to be configured to generate one or more different variations of how the story is told to address the specific target audience or person.

According to the exemplary embodiment, the orchestration manager 110 is configured to use historical and predictive data analysis on viewership, advertising served and pricing/margin, trending topics on social media and ability to engage the consumer provided by one or a plurality of engines configured to generate an optimized lineup (or lineups). It should be appreciated that this automated lineup provides the best ROI based on content topics, immediacy, real time trending, time spent and depth such as when a consumer views it and then searches for more information related to the event along with ads served, pricing and margin obtained through the story's life cycle.

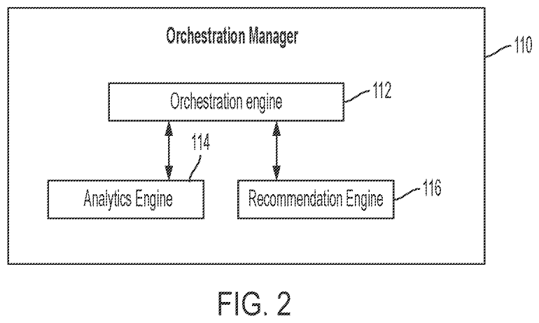

FIG. 2 illustrates a block diagram of the orchestration manager 110 configured for implementing system 100 for AI driven orchestration automation of live production and channel playout according to an exemplary embodiment. As shown, orchestration manager 110 includes orchestration engine 112, analytics engine 114 and recommendation engine 116, the details of which will be described below.

In general, each of the engines may be configured as module for executing the algorithms disclosed herein. Moreover, the term “module” refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general purpose computer. Accordingly, each module can be realized in a variety of suitable configurations, and should not be limited to any example implementation exemplified herein.

According to the exemplary aspect, the orchestration engine 112 can be configured to coordinate the delivery of content to various streaming sources, for example, the OTT platforms 104, multi-cast, broadcast, MPVDs (multichannel video programming distributors), and the like.

Moreover, the analytics engine 114 is configured to generate the final automation control stream for continuous program feeds that target a customer, or customer set, based on their psychographic data, profile and current active content selections. For example, the analytics engine 114 is configured to mine data regarding targeted customer or customer set (also taking into account viewing client/destination, i.e., mobile, connected TV, and time-of-day, duration of content consuming activity, and the like), based on their psychographic data, profile and current active content selections. Upon the completion of analysis, analytics engine 114 is configured to provide the optimal personalized or recommended final automation control stream and “creative” suggestion for new content.

The recommendation engine 116 is further configured to suggest content lists of at least one item targeted for a customer, or customer set, based on their psychographic data and profile. More particularly, the recommendation engine 116 is configured to constantly work to provide the consumer or consumer set, based on their psychographic data and profile, the appropriate suggested content or content list such as a predefined playlist made up of VOD content, live stream and/or playout channel based on programming schedule and time-of-day.

As noted above, the orchestration engine 112 is configured to manage the content throughout the workflow process. In an exemplary aspect, the orchestration engine 112 can either include and/or be configured to control one or more media content delivery servers for distributing (e.g., streaming, broadcasting or the like) the designated media content for the live product using the dynamically controlled rundown or playlist using the algorithms described herein. More particularly, the orchestration engine 112 can be configured to control a media content distribution server to distribute media content for the live production based on the established optimal prioritization and order for the rundown and/or playlist.

As described above, conventional NRCSs, Live Storyboarding Software and/or Playout Playlists today expect producers, directors or other show planners to manually enter the running order of stories, topical content or shows. According to the exemplary embodiment, the orchestration manager 110 (including engines 112, 114 and 116) is configured to automate these components and the decisioning based on trending topics, content and/or advertisement sales performance by daypart or viewership. In this aspect, the orchestration engine 112, the analytics engine 114 and the recommendation engine 116 can be configured by artificial intelligence and/or predictive machine learning processes to facilitate the live production and channel playout.

During operation, as the analytics engine 114 makes recommendations for content to be suggested and/or included within a rundown, playlist or channel playout schedule, the content upon completion or previously stored in archive should also be entered (e.g., loaded and/or stored) into the recommendation engine 116. In one aspect, the recommendation engine 116 is configured to associate the content with consumers based on their viewing and search history or predictive interests. If the content is broadcast and/or streamed live with additional introductions, tags or other live inserts to augment the story or program that is processed through an automated clipping service (e.g., an automated VOD), the recommendation engine 116 can process this content the same as if it were pre-produced content.

In addition, advertisers (and advertisement insertions, for example) are also selected based on content category preferences and predictive consumer profiles. The recommendation engine 116 is then configured to place the content metadata, thumbnails and/or description into search engines such as Google®, Bing®, Yahoo® or Yandex®, as examples and on broadcaster/programmer online content management systems (CMS), social media platforms such as Facebook®, Instagram®, Twitter® or any other user interface application such as the front-end of an OTT player (e.g., OTT platforms 104) or mobile app. In turn, the orchestration layer engine 112 is configured to manage the above application as it relates to VOD content assets, for example.

Thus, through the use of orchestration engine 112, the analytics engine 114 and the recommendation engine 116, the orchestration manager 110 is configured to manage and automate workflows that simultaneously covers: rundown generation and real time change management (example application—newscast), playlist generation and real time change management (example application—live sports and entertainment), channel playout schedule generation and real time change management (example application—TV, network or managed services channel playout), and/or video-on-demand (VOD) generation and real time change management (example application—recommendation engine, search or consumer driven predefined topical profile).

In a refinement of the exemplary aspect, the orchestration engine 112 is configured to monitor channel playout and dynamically adjust the rundown and playout of the media content. More particularly, managed services playout facilities will typically have substantial personnel resources at monitoring stations that are effectively “watching” feedback monitors for each program output channel. According to the exemplary aspect, the orchestration engine 112, using AI or machine learning, for example, is configured to monitor video output signals (being transmitted to content consumers) and generate alarms and/or engage corrective action or backup processes based on issues of the content deliver, such as blackouts, program output freeze, audio lip sync misalignment, sever pixelization error, and the like. As such, the orchestration engine 112 is configured to provide sufficient reliability and confidence to remove a human monitoring of content playout.

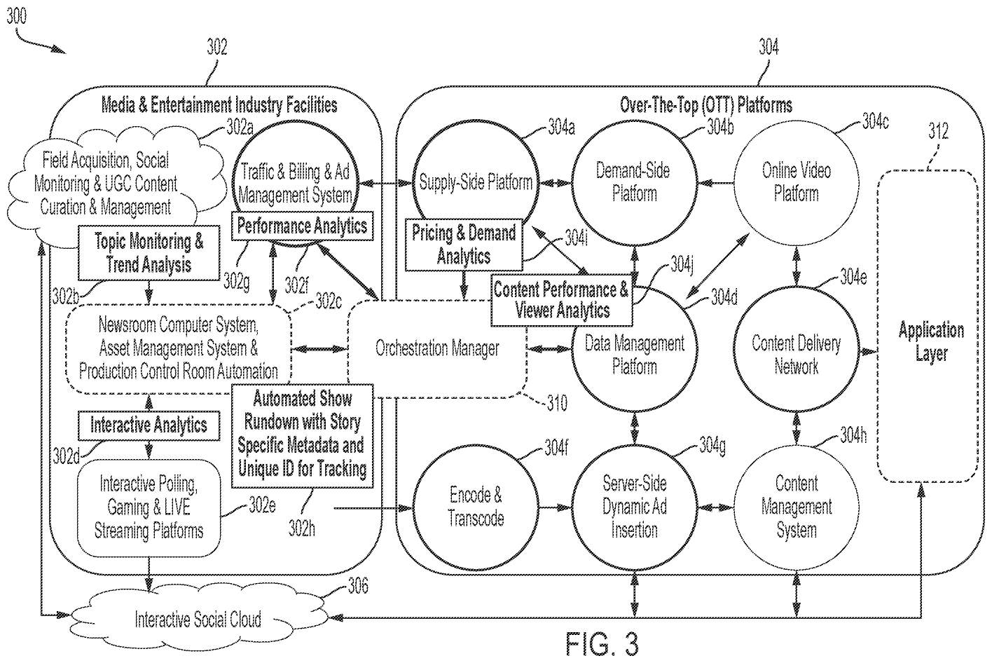

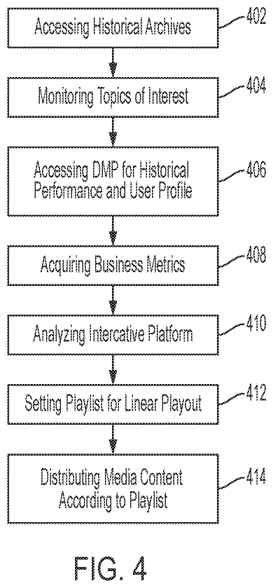

FIG. 3 illustrates a detailed block diagram of an exemplary system 300 for AI driven orchestration automation of live production and channel playout according to an exemplary embodiment. In general, it is noted that certain components shown in FIG. 4 correspond to those component of FIG. 1. For example, media and entertainment industry facilities 302 corresponds to component 102, OTT platforms 304 correspond to platforms 104, interactive social cloud 306 corresponds to cloud 106 and orchestration manager 310 corresponds to orchestration manager 110, and can also include orchestration engine 112, analytics engine 114 and recommendation engine 116, as described above.

As described above, the recommendation engine 116 is configured to suggest content lists of at least one item targeted for a customer, or customer set, based on their psychographic data and profile, while the analytics engine 114 is configured to generate the final automation control stream for continuous program feeds that target a customer, or customer set, based on their psychographic data, profile and current active content selections. As shown in FIG. 3, the media and entertainment industry facilities 302 can include a number of components/applications that include, for example, an engine 302a for field acquisition, social monitoring and UGC content curation and management, a traffic and billing and advertisement management system 302f, interactive polling, gaming and live streaming platforms 302e, and newsroom computer system (MRCS), asset management system and production control room automation 302c.

As further shown, through these platforms, the orchestration manager 310 is configured to execute the algorithms described herein for topic monitoring and trend analysis 302b, performance analytics 302f, and interactive analytics 302d, for purposes of building the automated show rundown (and/or playlist) with story specific metadata and unique ID for tracking for analytics to dynamically adjust the show rundown (and/or playlist) during video production play out.

As further shown, the orchestration manager 310 is configured to manage the delivery of the video content of the live video production to content consumers via application layer 312, for example. In general, the application layer 312 can be one or more content consumption platforms for end users to receive an consume the determined media content. For example, the applications can run on one or more consumer devices including, a smart TV, computer, laptop, tablet, smart phone and/or the like. Moreover, the application layers 312 can be presented on a third-party content consuming application, such as Facebook® or YouTube®, for example.

Moreover, the content delivery network 304e can be any existing infrastructure, such as a geographically distributed network of proxy servers (e.g., media content delivery servers) and data centers for distributing the content to the application layer 312. The content delivery network 304e is further coupled to the content management system 304h that is configured to manage the creation and modification of the digital media content to ultimately be distributed to the content consumers via the content delivery network 304e. In an exemplary aspect, the content management system 304h is composed of a content management application that provides front-end user interface that allows the operator of the orchestration manager 310 to add, modify, and remove content according to the methodologies disclosed herein. Moreover, the content management system 304h can further include a content delivery application that is configured to compile the content according to the dynamically modified rundown and playlist, according to an exemplary aspect.

The system 300, and specifically the OTT platforms can further include encoders and transcoders (e.g., encode and transcode 304f) and a server-side dynamic advertisement insertion engine 304g. An example of an existing system of these components is described in U.S. Pat. No. 10,200,749, entitled “Method and Apparatus for Content Replacement in Live Production”, issued on Feb. 5, 2019, the contents of which are hereby incorporated by reference.

The data management platform 304d can further be provided to work with the analytics engine 114 (or composed as a component of the analytics engine 114) for collecting and managing the data described herein. For example, in one aspect, the data management platform 304d can include a platform performance metrics module configured to generate performance metrics for at least one downstream platform with at least one of targeted consumer profiles, advertiser interests and predictive ROI based on content type, duration, real time trends and performance metrics, acquired by one or more of the platforms of media and entertainment industry facilities 302.

As finally shown, the system 300, and specifically the OTT platforms 304, can further include supply-side platform 304a, demand-side platform 304b and online video platform 304c. In an exemplary aspect, the online video platform 304c can provided by a video hosting service and can be configured to enable an operator of system 300 to upload, convert, store and play back video content on to one or more application layers 312. Moreover, supply-side platform 304a and demand-side platform 304b can be conventional advertisement platforms that can be utilized by orchestration manager 310 for delivering the video content as part of the live video production, using the content delivery algorithms described herein.

FIG. 4 illustrates a flowchart for a method 400 configuring orchestration manager 110/310 (e.g., the software platform) according to an exemplary aspect. It is noted that method 400 is described has configuring orchestration manager 110, but this method also applies to the configuring of orchestration manager 310 as should be appreciated to those skilled in the art.

Initially, at step 402, the orchestration manager 110 is configured to collect and/or access and then review data generated by analytics engine 114. This data is generated based on historical daily archives related to time-of-day, content topics and average duration of play and performance results based on number of ads served, types of ads, pricing, margin and costs and traffic lists from the Advertising Management System (AMS) and Media Asset Management (MAM) and Storage/Archive systems.

Next, at step 404, the orchestration manager 110 is configured to monitor and identify trending stories and topics of interest, number of viewers and shares, number of story requests for more detailed information, and checks on ancillary reports, such that the orchestration manager can define a level of interest and depth for story creation. It is noted that steps 402 and 404 can be executed in sequence or parallel as would be appreciated to one skilled in the art.

At step 406, the orchestration manager 110 is configured to access and review data generated by Recommendation Engine 116. This engine 116 uses information from Data Management Platform (DMP) for historical performance views of topics by platform and user profile in addition to advertiser topical interest and pricing potential based on supply and demand in conjunction with metrics from the Supply-Side Platforms (SSP) and Demand-Side Platform (DSP). An exemplary technique for the data gathering and access for historical performance review is described U.S. Pat. No. 10,129,604, issued Nov. 13, 2018, and entitled “Analytic System for Automatically Combining Advertising and Content in Media Broadcasts”, which is herein incorporated by reference.

In any event, at step 408, the orchestration manager 110 is then further configured to acquire the business metrics, for example, pricing, bandwidth, scale for doing business with Amazon AWS®, Google Cloud® and/or Microsoft Azure®, such that a generated ROI model can take into account the variables of the different platforms. This accounts for IaaS categories like Encode/Transcode 3044, Server-Side Dynamic Ad Insertion 304g, Data Management Platform 304d, Content Delivery Network 304e and Demand-Side Platform Advertising 304b services and their third party partners for Online Video Platforms 304c and Content Management Systems 304h. In an exemplary aspect, the orchestration manager 110 can be configured to use at least one of Infrastructure as Code (“IAC”) and Configuration as Code (“CAC”) to ensure the “factory” for each cloud is configured optimally. For example, while the cloud provider (e.g., Amazon AWS®) is offering IaaS as a service, the orchestration manager 110 can be configured to use IAC/CAC to optimize the ROI on a unique cloud platform (e.g., interactive social cloud 106).

At step 410, the orchestration manager 110 can also be configured to access social and/or interactive platforms to derive level of interest for specific content types and categories for selection and duration of engagement. For example, the orchestration manager can be configured to collect data relating to interests (e.g., sports vs. shopping) for an individual or group of individual consumers. Such analysis can be performed by collecting the number of views (e.g., number of likes on such platforms), for example.

According to the exemplary aspect, the orchestration manager 110 is then configured to learn and predict the ROI performance of variations (using AI or machine learning, for example) to establish the best prioritization and order of rundown or playlist or schedule for linear playout at step 412. This same process can take place for a live sports or entertainment event where rather than a scripted list, a real time event by event suggestion will be displayed in hierarchical order either automated and executed or for decisioning by the producer and/or director via a user interface generated by the orchestration manager. It should be appreciated that other functions for the applications may include more data metrics especially as it relates to sports where consumers want to view real time performance metrics or archived historical data on the specific event, team matchups, and/or player. When combined with real time trending results, the AI implemented by the orchestration manager 110 can be configured to generate the “what”, “where” and “when” for this data and other associated media should be recalled, embedded in graphics as an overlay or full screen presentation automatically.

Thus, according to the exemplary embodiment of method 400, it should be appreciated that the orchestration manager 110 is configured to use the data science along with the data gathered from other sources to intelligently automate the rundown and playlist assembly based on maximizing ROI. Based on a predictive rundown and playlist that can be presented on a user interface, the Producer/Director can then be prompted to select either to accept the automated outcome our manually intervene as needed.

Moreover, it is noted that while the orchestration manager 110 is configured to use artificial intelligence and machine learning to identify the priorities in order to deliver the highest ROI, the orchestration manager 110 can also be driven critical factors as designated by the broadcaster and their advertisers according to a refinement of the exemplary aspect. For example, in one exemplary aspect, the orchestration manager 110 is configured to provide a user interface that enables a user (e.g., the producer/director) to define which categories of data should be afforded different weights according to user preferences. For example, if an advertiser such as NIKE® wants to focus on young males with disposable income that watch their local sports team regularly, the broadcasters and/or advertisers can prioritize “mobile data” versus “TV” based on demographics and preferred screen data or even the fact that they share an interest in “gaming” (i.e., they may want to also prioritize “Gaming”). In other words, the orchestration manager 110 is configured to target media content consumers with data configured to be most likely consumed by such individuals.

Yet further, the broadcaster may weigh other factories more heavily based on preference, such as QoS and QoE plus automated CDN (content delivery network) switching to provide the best quality of performance for the stream. Thus, the user can assign a priority or even generate a weighting factor (e.g., a percentage) that dynamically controls the AI of the orchestration manager 110 to weigh certain types of data more heavily when automatically generating the predictive rundown and/or playlist or channel playout schedule.

Yet further, even these weighting factors and user preference can be learned and subsequently used. For example, the orchestration manager 110 can be configured to prioritize and/or weigh factors as set by a given Producer or Director for a given type of event (e.g., a baseball game). Over time, the orchestration manager 110 can collect this data to further develop the predictive rundown and playlist that is then presented on the user interface for a subsequent live event, effectively minimizing the subsequent processing time required to generate such predictive controls.

In yet a further refinement of the exemplary embodiment, the orchestration manager 110 is configured to generate and/or store a set profile for each broadcaster for one or more of their rundowns, playlists or channel playout schedules (which can be content specific). For example, in the case of a newscast application, the first block (block A) of programming may be used for the hottest trending topics while they prefer block B or C to focus in on and include either sports or weather. The orchestration manager 110 can be configured to use rules to have AI determine the line up by category unless breaking news needs to override a decision and or preferred profile. In this aspect, the orchestration manager 110 can be configured to “learn” over time as dynamic changes are made which changes were effective versus non-effective in delivering the expected ROI. For example, orchestration manager 110 is configured to monitor viewership based on such changes and dynamically update its database and profile of users and consumers in order to adjust the content of playlists for future playout to the same or similarly situated/profiled consumers of similar content.

Moreover, in some instances using conventional systems, one or more unwanted stories in a rundown may unnecessarily be transmitted to an end consumer that is uninterested and will not watch the store. As a result, the production systems waste unnecessary processor resources and unnecessarily consume bandwidth for transmitting these unwanted stories. According to the exemplary aspect, if the AI of the orchestration manager 110 initially develops a rundown based on the broadcasters preferred profile and rules, but breaking news happens, the orchestration manager 110 can be configured to automatically/dynamically change the rundown by dropping a story or presenting the option to the Director. In addition, the director can establish rules for the orchestration manager 110 to automatically prevent preventing some categories from being affected, using a user interface for setting predefined rules, for example.

In any event, according to the exemplary system and method described herein, the orchestration manager 110 is configured to use AI as a means to analyze and project the best use of content by priority lineup (i.e., rundown or playlist) to maximize ROI based on an orchestration management software and/or platform that is coordinating multi-platform content creation, production, distribution and monetization. According to an exemplary aspect, this management can be on premise, cloud-based or hybrid and leverages both traditional Traffic & Billing and SSP Platforms for Pricing & Demand Analytics as well as historical Performance Analytics from previous content lineups.

As described above, the orchestration manager 110 for automation of live production and channel playout can be implemented as one or more computer systems configured to execute the algorithms described herein. In one exemplary aspect, the orchestration manager 110 can be implemented as a cloud-based solution. In another exemplary aspect, the orchestration manager 110 can be implemented as a hardware computer system.

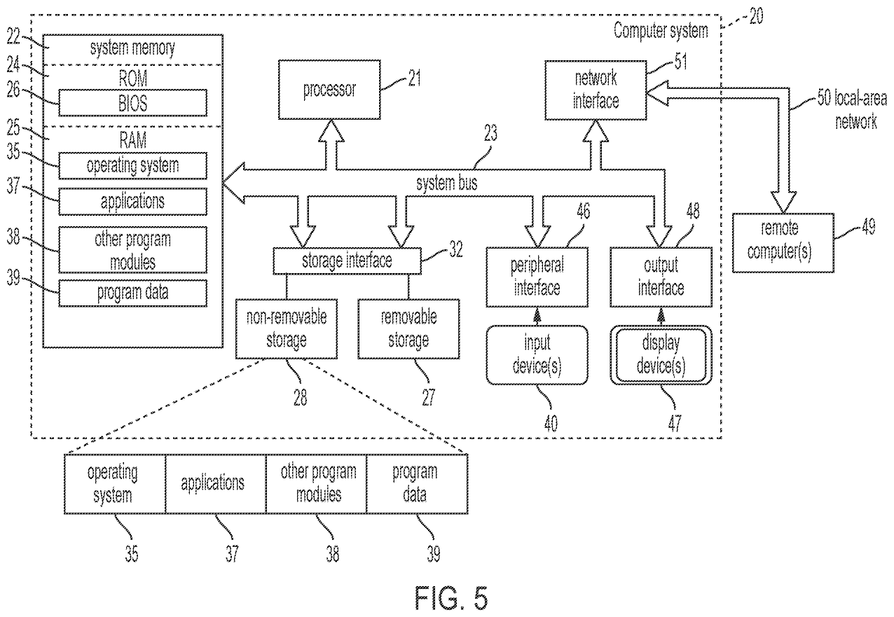

FIG. 5 is a block diagram illustrating a computer system on which aspects of systems and methods for AI driven orchestration automation of live production and channel playout according to an exemplary embodiment. In an exemplary aspect, the computer system 20 can be configured as orchestration manager 110 and/or one or more of orchestration engine 112, analytics engine 114 and recommendation engine 116, according to various exemplary aspects.

As shown, this block diagram illustrates a computer system 20 on which aspects of orchestration manager for automation of live production and channel playout may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

Moreover, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable codes implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20. It should be appreciated that one or more of these memory modules can be configured to collect and store the metrics data described above as would be appreciated to one skilled in the art.

Moreover, the system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces. It should be appreciated that the one or more remote computers may also be other computing devices of which the metrics data is collected as described above.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of the skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A system for orchestrating automation of live production and channel playout, the system comprising:
an analytics engine configured to generate historical performance metrics based on a historical archive review and prioritization of media content, wherein the analytics engine includes a platform performance metrics module configured to generate performance metrics for at least one downstream platform with at least one of targeted consumer profiles, advertiser interests and predictive ROI based on content type, duration, real time trends and performance metrics;
a recommendation engine configured to monitor and identify at least one topic of interest that aligns with the generated historical performance metrics for decisioning, wherein the recommendation engine includes a ROI projector configured to access at least one of social and interactive platforms to derive at least one level of interest for a specific content type and categories for selection and duration of engagement based on the generated historical performance metrics for decisioning and the generated performance metrics for at least one downstream platform, to generate a projected ROI performance based on historical metrics;
an orchestration engine configured to learn variations of the projected ROI performance to establish an optimal prioritization and order for at least one of rundown and a playlist for live video production; and
a media content distribution server configured to distribute media content for the live video production based on the established optimal prioritization and order for the at least one of the rundown and playlist;
wherein the orchestration engine is further configured to generate a user interface configured to receive weighting factors for at least a portion of the historical performance metrics, at least one topic of interest that aligns with the generated historical performance metrics for decisioning, and the generated performance metrics for at least one downstream platform configured to receive the live product including the media content, and
wherein the orchestration engine is further configured to dynamically adjust the established optimal prioritization and order for the at least one of rundown and a playlist in response to an adjustment of the weighting factors received by the user interface.

2. The system according to claim 1, wherein the orchestration engine is further configured to embed an additional graphic relating to the identified at least one topic of interest into the live video production.

3. The system according to claim 1, wherein the analytics engine is further configured to monitor viewership of the live product and to dynamically update the established optimal prioritization and order for the at least one rundown or playlist based on feedback data of the monitored viewership.

4. The system according to claim 1, wherein the orchestration engine is configured to dynamically update the established optimal prioritization and order for the at least one rundown or playlist by dropping a story based on the feedback data of the monitored viewership.

5. The system according to claim 1, wherein the orchestration engine is configured to use at least one of infrastructure as code and configuration as code to establish the optimal prioritization and order for the at least one of the rundown and the playlist for the live video production.

6. The system according to claim 1, wherein the analytics engine is configured to monitor a video output signal of the live video production to identify an error with content delivery of the live video production, with the error being one of a blackout, a program output freeze, an audio lip sync misalignment and a pixelization error.

7. The system according to claim 6, wherein the orchestration engine is configured to dynamically update the established optimal prioritization and order for the at least one rundown or playlist in response to the identified error of the content delivery.

8. A system for orchestrating automation of a production and channel playout, the system comprising:
an analytics engine configured to:
generate historical performance metrics based on a historical archive review and prioritization of media content, and
to generate performance metrics for at least one downstream platform with at least one of targeted consumer profiles, advertiser interests and predictive ROI based on content type, duration, real time trends and performance metrics;
a recommendation engine configured to:
monitor and identify at least one topic of interest that aligns with the generated historical performance metrics for decisioning, and
to access at least one of social and interactive platforms to derive at least one level of interest for a specific content type and categories for selection and duration of engagement based on the generated historical performance metrics for decisioning and the generated performance metrics for at least one downstream platform, to generate a projected ROI performance based on historical metrics;
an orchestration engine configured to learn variations of the projected ROI performance to establish an optimal prioritization and order for at least one of rundown and a playlist for a video production; and
a media content distribution server configured to distribute the video production based on the established optimal prioritization and order for the at least one of the rundown and playlist;
wherein the orchestration engine is further configured to dynamically adjust the established optimal prioritization and order for the at least one of rundown and a playlist in response to inputs received from a user interface.

9. The system according to claim 8, wherein the orchestration engine is further configured to generate the user interface that is configured to receive weighting factors for at least a portion of the historical performance metrics, at least one topic of interest that aligns with the generated historical performance metrics for decisioning, and the generated performance metrics for at least one downstream platform configured to receive the live product including the media content.

10. The system according to claim 9, wherein the orchestration engine is further configured to dynamically adjust the established optimal prioritization and order for the at least one of rundown and a playlist in response to an adjustment of the weighting factors received by the user interface.

11. The system according to claim 8, wherein the orchestration engine is further configured to embed an additional graphic relating to the identified at least one topic of interest into the live production.

12. The system according to claim 8, wherein the analytics engine is further configured to monitor viewership of the live product and to dynamically update the established optimal prioritization and order for the at least one rundown or playlist based on feedback data of the monitored viewership.

13. The system according to claim 8, wherein the orchestration engine is configured to dynamically update the established optimal prioritization and order for the at least one rundown or playlist by dropping a story based on the feedback data of the monitored viewership.

14. The system according to claim 8, wherein the orchestration engine is configured to use at least one of infrastructure as code and configuration as code to establish the optimal prioritization and order for the at least one of the rundown and the playlist for the live video production.

15. The system according to claim 8, wherein the analytics engine is configured to monitor a video output signal of the live production to identify an error with content delivery of the live production, with the error being one of a blackout, a program output freeze, an audio lip sync misalignment and a pixelization error.

16. The system according to claim 15, wherein the orchestration engine is configured to dynamically update the established optimal prioritization and order for the at least one rundown or playlist in response to the identified error of the content delivery.

17. A system for orchestrating automation of live production and channel playout, the system comprising:
analytics means for generating historical performance metrics based on a historical archive review and prioritization of media content;
means for generating performance metrics for at least one downstream platform with at least one of targeted consumer profiles, advertiser interests and predictive ROI based on content type, duration, real time trends and performance metrics;
recommendation means for monitoring and identifying at least one topic of interest that aligns with the generated historical performance metrics for decisioning;
ROI projecting means for accessing at least one of social and interactive platforms to derive at least one level of interest for a specific content type and categories for selection and duration of engagement based on the generated historical performance metrics for decisioning and the generated performance metrics for at least one downstream platform, to generate a projected ROI performance based on historical metrics;
orchestration means for learning variations of the projected ROI performance to establish an optimal prioritization and order for at least one of rundown and a playlist for live video production; and
a media content distribution server configured to distribute media content for the live video production based on the established optimal prioritization and order for the at least one of the rundown and playlist;
wherein the orchestration means is further configured for generating a user interface configured to receive weighting factors for at least a portion of the historical performance metrics, at least one topic of interest that aligns with the generated historical performance metrics for decisioning, and the generated performance metrics for at least one downstream platform configured to receive the live product including the media content, and
wherein the orchestration means is further configured for dynamically adjusting the established optimal prioritization and order for the at least one of rundown and a playlist in response to an adjustment of the weighting factors received by the user interface.

18. The system according to claim 17, wherein the orchestration means is further configured for embedding an additional graphic relating to the identified at least one topic of interest into the live video production.

19. The system according to claim 17, wherein the analytics means is further configured for monitoring viewership of the live product and dynamically updating the established optimal prioritization and order for the at least one rundown or playlist based on feedback data of the monitored viewership.

20. The system according to claim 17, wherein the orchestration means is further configured for dynamically updating the established optimal prioritization and order for the at least one rundown or playlist by dropping a story based on the feedback data of the monitored viewership.

21. The system according to claim 17, wherein the orchestration means is further configured for using use at least one of infrastructure as code and configuration as code to establish the optimal prioritization and order for the at least one of the rundown and the playlist for the live video production.

22. The system according to claim 17, wherein the analytics means is further configured for monitoring a video output signal of the live video production to identify an error with content delivery of the live video production, with the error being one of a blackout, a program output freeze, an audio lip sync misalignment and a pixelization error.

23. The system according to claim 22, wherein the orchestration means is further configured for dynamically updating the established optimal prioritization and order for the at least one rundown or playlist in response to the identified error of the content delivery.
